(19) United States
(12) Patent Application Publication
(10) Pub. No.: US 2016/0291989 A1
(43) Pub. Date: Oct. 6, 2016

(54) METHOD AND SYSTEM FOR APPLYING OPTIMAL SETTINGS FROM FIRST INVOCATION OF A GAMING APPLICATION

(71) Applicant: NVIDIA Corporation, Santa Clara, CA (US)

(72) Inventors: John SPITZER, San Jose, CA (US); Oleg VINOGRADOV, Santa Clara, CA (US); Jen-Hsun HUANG, Los Altos Hills, CA (US); Nikita KONYUCHENKO, Santa Clara, CA (US); Anthony Michael TAMASI, San Jose, CA (US)

(21) Appl. No.: 14/673,641

(22) Filed: Mar. 30, 2015

(51) Int. Cl. G06F 9/445

(52) U.S. Cl. CPC G06F 9/44505

(57) ABSTRACT

A method for optimizing a user's experience. The method includes detecting a newly discovered gaming application on a computing device, and receiving an instruction to optimize the newly discovered gaming application. The method includes determining a hardware configuration for the computing device. The method includes accessing pre-defined optimal settings based on the gaming application and the hardware configuration, and writing the pre-defined optimal settings into a game settings file associated with the gaming application.

### BACKGROUND

An application such as a video game is executed on hardware, to include at a minimum, a processor, a graphics processor, and a display. Performance of the application (e.g., speed) is dependent on the settings applied to the hardware configuration used for executing the application. In some cases, the hardware configuration settings of a gaming platform are not optimized for a given application. For instance, the settings may result in poor execution of the application, wherein visual effects are sacrificed or eliminated. This may occur when the settings are not taking full advantage of the capabilities of the hardware configuration, or when the settings are overly ambitious for the given hardware configuration. In either case, the image quality of the executed application suffers.

The hardware configuration settings may be tailored to an application. For example, an application may include an optimization routine that automatically sets the hardware configuration to default settings when the user first invokes the application. However, one of the weaknesses of these in-game optimization routines is that the settings are fairly conservative, since the default settings are generally targeted to a broad range of user platforms. As such, these default settings are not wholly optimized to a particular user's gaming platform. In that case, when the user first executes the application using the default settings, that user may be underwhelmed with his or her gaming experience when playing that application. That user may be so underwhelmed so as to prompt a return of the application.

Further, the user may also customize the settings to the hardware configuration for a particular application. However, many times, this option is not exercised for a myriad of reasons. For example, the user may just want to try out the application on a trial basis without going through the manual, customization process. In that case, the user relies on the possibly underperforming default settings provided by the application. As another example, the user may not know enough about how the settings affect the performance of the gaming application, and as such will unknowingly select unoptimized settings for a given hardware platform. Again, the user's gaming experience will suffer when executing the application for the first time, such as experiencing low image quality or low frame rates.

### SUMMARY

In embodiments of the present invention, a computer implemented method for optimizing configuration settings is disclosed. In other embodiments, a non-transitory computer readable medium is disclosed having computer-executable instructions for causing a computer system to perform a method for optimizing configuration settings. In still other embodiments, a computer system is disclosed comprising a processor and memory coupled to the processor and having stored therein instructions that, if executed by the computer system, cause the computer system to execute a method for optimizing configuration settings. The method includes detecting a newly discovered gaming application on a computing device. The method includes receiving an instruction to optimize the newly discovered gaming application. The method includes determining a hardware configuration for the computing device. The method includes accessing pre-defined optimal settings based on the gaming application and the hardware configuration. The method includes writing the pre-defined optimal settings into a game settings file associated with the gaming application.

In another embodiment, a system for optimizing configuration settings. The system includes a gaming application detector configured for detecting a newly discovered gaming application on a computing device. The system includes a resource discovery module configured for determining a hardware configuration for the computing device. The system includes an optimizer configured for receiving an instruction to optimize the newly discovered gaming application, for accessing pre-defined optimal settings based on the gaming application and the hardware configuration, and for writing the pre-defined optimal settings into a game settings file associated with the gaming application.

These and other objects and advantages of the various embodiments of the present disclosure will be recognized by those of ordinary skill in the art after reading the following detailed description of the embodiments that are illustrated in the various drawing figures.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 depicts a block diagram of an exemplary computer system suitable for implementing embodiments according to the present disclosure.

FIG. 2 is a block diagram of an example of a client device capable of implementing embodiments according to the present disclosure.

FIG. 3 is a block diagram of an example of a network architecture in which computing devices capable of applying optimized settings to a game settings file are coupled through a network to a back end server providing gaming services, in accordance with one embodiment of the present disclosure.

FIG. 4 is a block diagram of an optimizing management module configured for applying optimized settings to a game settings file that is associated with a gaming application as executed on a computing device, in accordance with one embodiment of the present disclosure.

FIG. 5 is a flow diagram illustrating a method for applying optimized settings to a game settings file that is associated with a gaming application as executed on a computing device, in accordance with one embodiment of the present disclosure.

FIGS. 6A-B is a flow diagram illustrating a method for applying optimized settings to a game settings file upon first invocation of a gaming application as executed on a computing device, in accordance with one embodiment of the present disclosure.

### DETAILED DESCRIPTION OF THE INVENTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “accessing,” “receiving,” “detecting,” “determining,” “writing,” “scanning,” or the like, refer to actions and processes (e.g., in flowcharts 5 and 6A-B of the present Application) of a computer system or similar electronic computing device or processor (e.g., computer system 100 and client device 200). The computer system or similar electronic computing device manipulates and transforms data represented as physical (electronic) quantities within the computer system memories, registers or other such information storage, transmission or display devices.

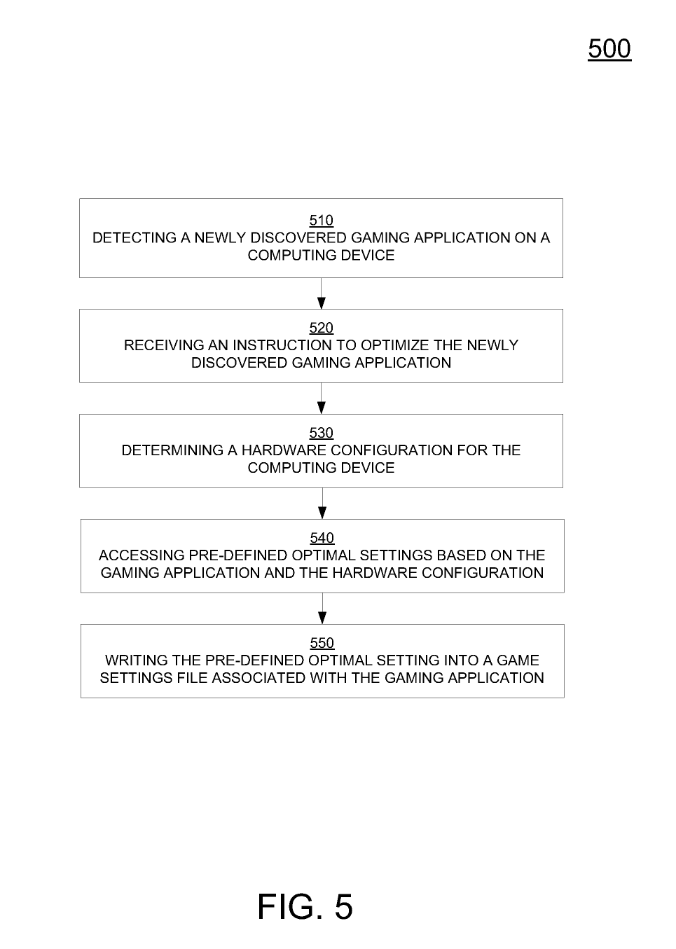

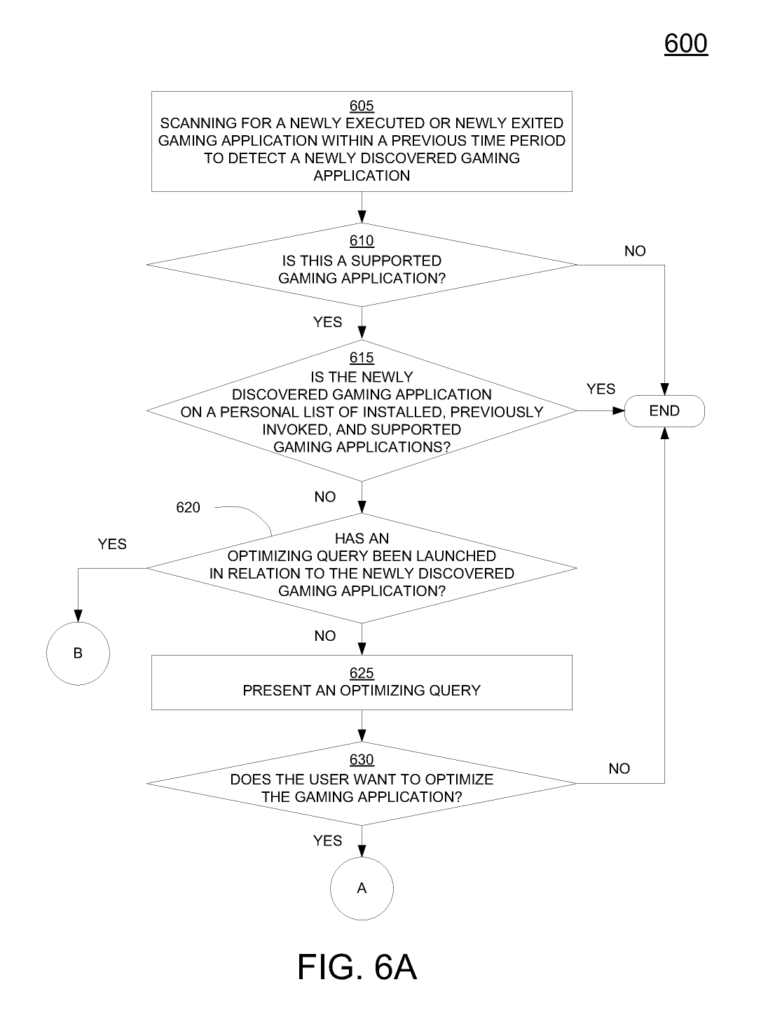

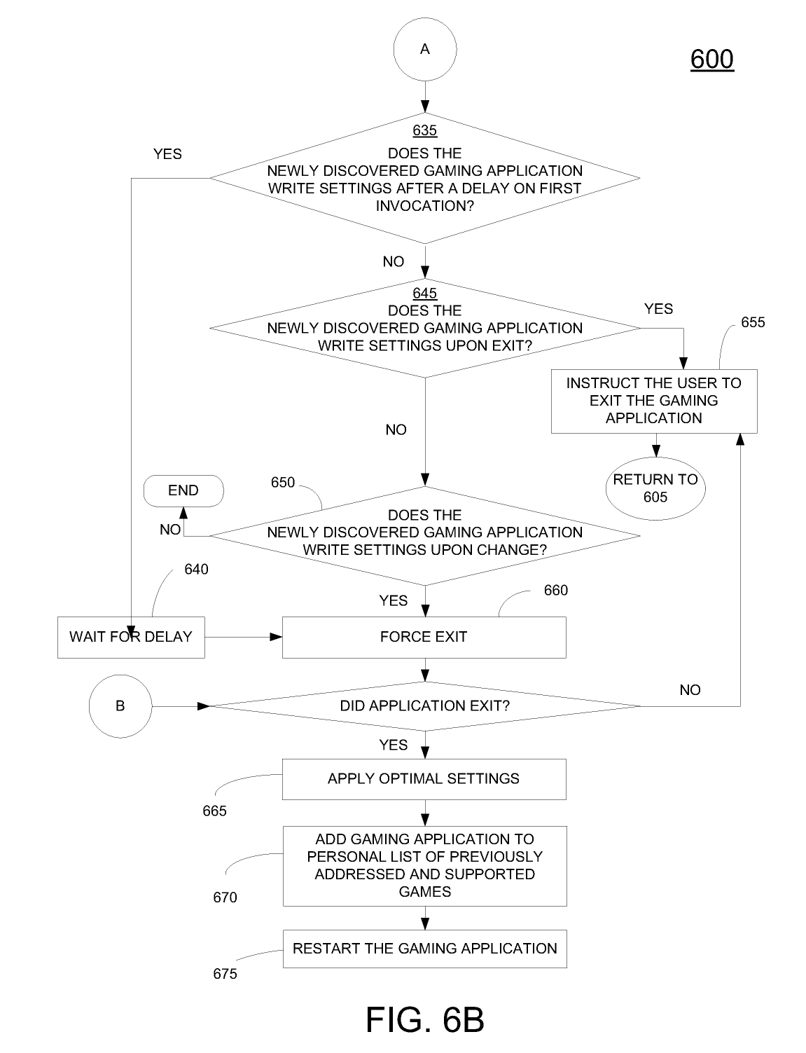

FIGS.5 and 6A-B are flowcharts of examples of computer-implemented methods for applying optimized settings to a game settings file that is associated with a gaming application as executed on a computing device, according to embodiments of the present invention. Although specific steps are disclosed in the flowcharts, such steps are exemplary. That is, embodiments of the present invention are well-suited to performing various other steps or variations of the steps recited in the flowcharts.

Other embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer storage media and communication media. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared and other wireless media. Combinations of any of the above can also be included within the scope of computer-readable media.

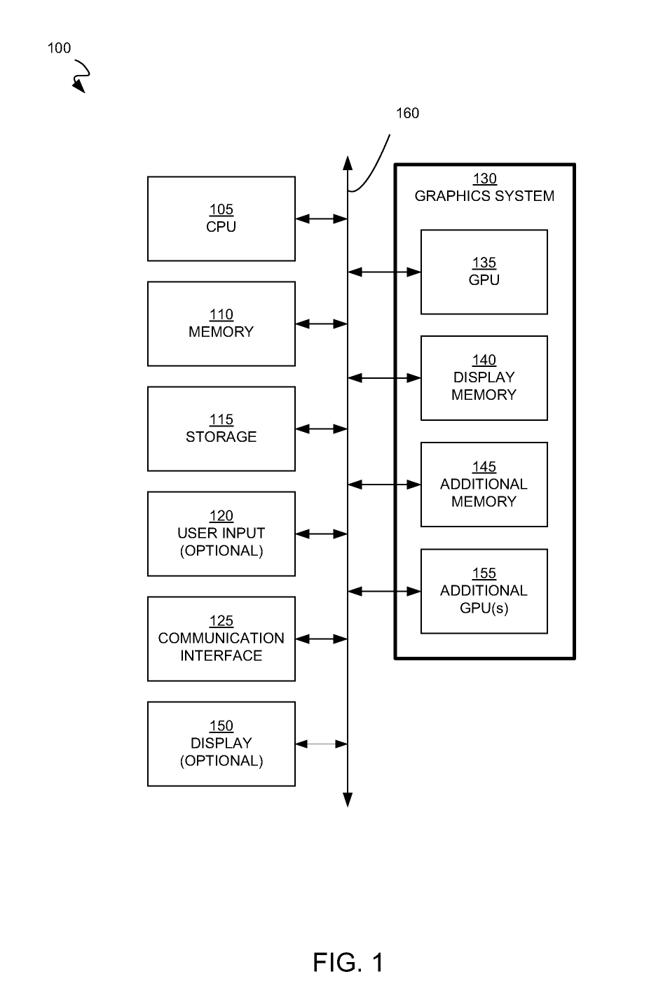

FIG. 1 is a block diagram of an example of a computing system 100 capable of implementing embodiments of the present disclosure. Computing system 100 broadly represents any single or multi-processor computing device or system capable of executing computer-readable instructions. Examples of computing system 100 include, without limitation, workstations, laptops, client-side terminals, servers, distributed computing systems, handheld devices, or any other computing system or device. In its most basic configuration, computing system 100 may include at least one processor 105 and a system memory 110.

It is appreciated that computer system 100 described herein illustrates an exemplary configuration of an operational platform upon which embodiments may be implemented to advantage. Nevertheless, other computer system with differing configurations can also be used in place of computer system 100 within the scope of the present invention. That is, computer system 100 can include elements other than those described in conjunction with FIG. 1. Moreover, embodiments may be practiced on any system which can be configured to enable it, not just computer systems like computer system 100. It is understood that embodiments can be practiced on many different types of computer systems 100. System 100 can be implemented as, for example, a desktop computer system or server computer system having a power general-purpose CPUs coupled to a dedicated graphics rendering GPU. In such an embodiment, components can be included that add peripheral buses, specialized audio/video components, I/O devices, and the like. Similarly, system 100 can be implemented as a handheld device (e.g., cell phone, etc.) or a set-top video game console device, such as, for example Xbox®, available from Microsoft corporation of Redmond, Wash., or the PlayStation3®, available from Sony Computer Entertainment Corporation of Tokyo, Japan. System 100 can also be implemented as a “system on a chip”, where the electronics (e.g., the components 105, 110, 115, 120, 125, 130, 150, and the like) of a computing device are wholly contained within a single integrated circuit die. Examples include a hand-held instrument with a display, a car navigation system, a portable entertainment system, and the like.

In the example of FIG. 1, the computer system 100 includes a central processing unit (CPU) 105 for running software applications and optionally an operating system. Memory 110 stores applications and data for use by the CPU 105. Storage 115 provides non-volatile storage for applications and data and may include fixed disk drives, removable disk drives, flash memory devices, and CD-ROM, DVD-ROM or other optical storage devices. The optional user input 120 includes devices that communicate user inputs from one or more users to the computer system 100 and may include keyboards, mice, joysticks, touch screens, and/or microphones.

The communication or network interface 125 allows the computer system 100 to communicate with other computer systems via an electronic communications network, including wired and/or wireless communication and including the Internet. The optional display device 150 may be any device capable of displaying visual information in response to a signal from the computer system 100. The components of the computer system 100, including the CPU 105, memory 110, data storage 115, user input devices 120, communication interface 125, and the display device 150, may be coupled via one or more data buses 160.

In the embodiment of FIG. 1, a graphics system 130 may be coupled with the data bus 160 and the components of the computer system 100. The graphics system 130 may include a physical graphics processing unit (GPU) 135 and graphics memory. The GPU 135 generates pixel data for output images from rendering commands. The physical GPU 135 can be configured as multiple virtual GPUs that may be used in parallel (concurrently) by a number of applications executing in parallel.

Graphics memory may include a display memory 140 (e.g., a frame buffer) used for storing pixel data for each pixel of an output image. In another embodiment, the display memory 140 and/or additional memory 145 may be part of the memory 110 and may be shared with the CPU 105. Alternatively, the display memory 140 and/or additional memory 145 can be one or more separate memories provided for the exclusive use of the graphics system 130.

In another embodiment, graphics processing system 130 includes one or more additional physical GPUs 155, similar to the GPU 135. Each additional GPU 155 may be adapted to operate in parallel with the GPU 135. Each additional GPU 155 generates pixel data for output images from rendering commands. Each additional physical GPU 155 can be configured as multiple virtual GPUs that may be used in parallel (concurrently) by a number of applications executing in parallel. Each additional GPU 155 can operate in conjunction with the GPU 135 to simultaneously generate pixel data for different portions of an output image, or to simultaneously generate pixel data for different output images.

Each additional GPU 155 can be located on the same circuit board as the GPU 135, sharing a connection with the GPU 135 to the data bus 160, or each additional GPU 155 can be located on another circuit board separately coupled with the data bus 160. Each additional GPU 155 can also be integrated into the same module or chip package as the GPU 135. Each additional GPU 155 can have additional memory, similar to the display memory 140 and additional memory 145, or can share the memories 140 and 145 with the GPU 135.

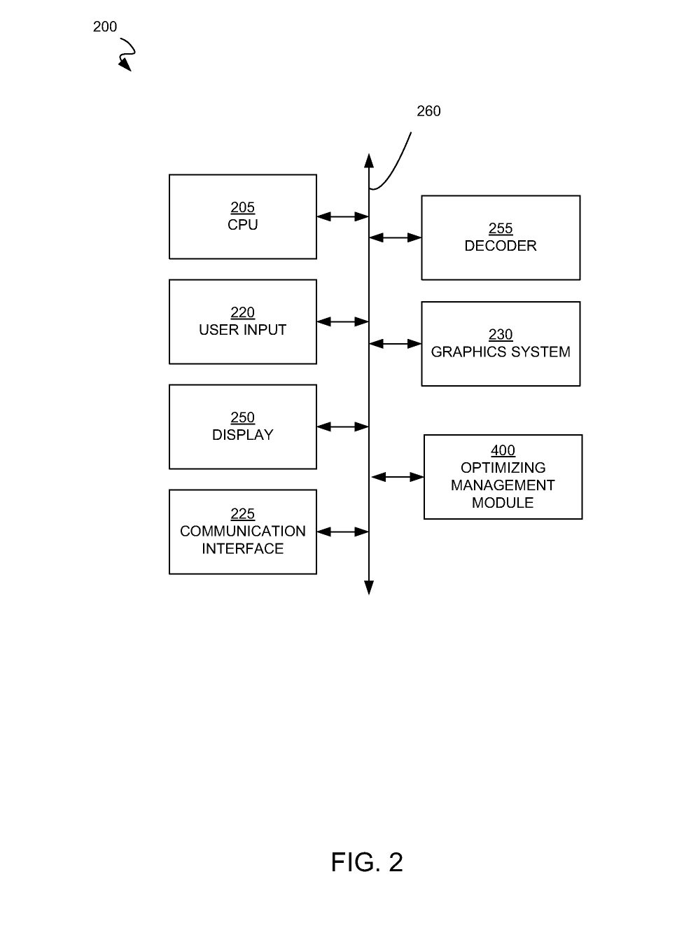

FIG. 2 is a block diagram of an example of an end user or client device 200 capable of implementing embodiments according to the present invention. In the example of FIG. 2, the client device 200 includes a CPU 205 for running software applications and optionally an operating system. The user input 220 includes devices that communicate user inputs from one or more users and may include keyboards, mice, joysticks, touch screens, and/or microphones.

The communication interface 225 allows the client device 200 to communicate with other computer systems (e.g., the computer system 100 of FIG. 1) via an electronic communications network, including wired and/or wireless communication and including the Internet. The decoder 255 may be any device capable of decoding (decompressing) data that may be encoded (compressed). For example, the decoder 255 may be an H.264 decoder. The display device 250 may be any device capable of displaying visual information, including information received from the decoder 255. The display device 250 may be used to display visual information generated at least in part by the client device 200. However, the display device 250 may be used to display visual information received from the computer system 100. The components of the client device 200 may be coupled via one or more data buses 260. Further, the components may or may not be physically included inside the housing of the client device 200. For example, the display 250 may be a monitor that the client device 200 communicates with either through cable or wirelessly.

Relative to the computer system 100, the client device 200 in the example of FIG. 2 may have fewer components and less functionality and, as such, may be referred to as a thin client. However, the client device 200 may include other components including all those described above with regard to the computer system 100, for example, graphics system 230 that may be similar to graphics system 130 of FIG. 1. In general, the client device 200 may be any type of device that has display capability, the capability to decode (decompress) data, and the capability to receive inputs from a user and send such inputs to the computer system 100. However, the client device 200 may have additional capabilities beyond those just mentioned. The client device 200 may be, for example, a personal computer, a tablet computer, a television, a hand-held gaming system, or the like.

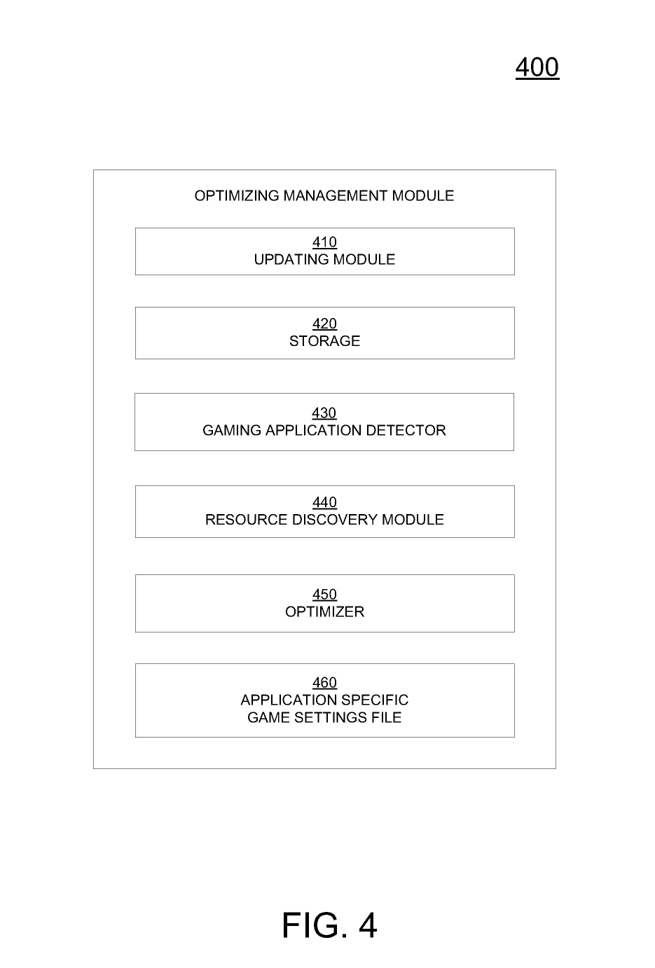

In addition, the computer system 100 includes an optimizing management module 400 that is configured for applying optimized settings to a game settings file that is associated with a gaming application as executed on local and/or remote computing resources, in accordance with one embodiment of the present disclosure. The optimizing management module 400 is described in more detail in relation to FIG. 4.

Throughout this Application, the term “gaming application” is used for illustration only, and embodiments of the present invention can be applied to any type of application. In one embodiment, an application is a video game application; however, the invention is not so limited. That is, the application can be any type of application. For example, the application may provide financial services, computer aided design (CAD) services, etc.

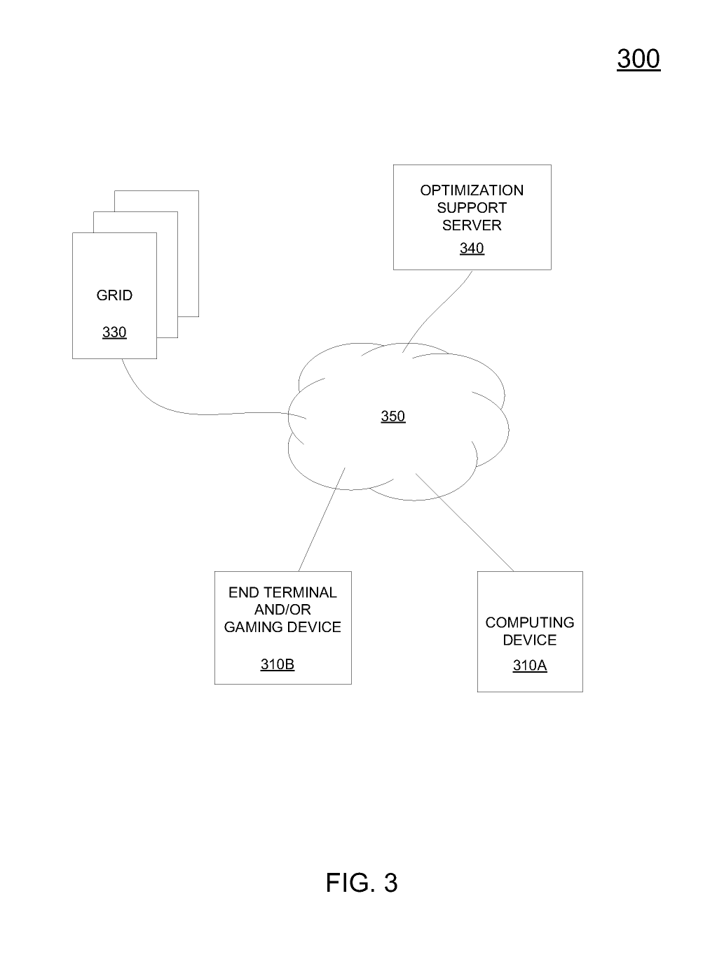

FIG. 3 is a block diagram of an example of a network architecture 300 in which a computing device 310A is coupled to an optimization support server 340 through a network for purposes of optimizing settings in the configuration file of the computing device 310A, in accordance with one embodiment of the present disclosure. For example, the computing device 310A is configured with an optimizing management module 400 in order to apply optimal settings to a gaming application before that application is played and/or executed for the first time. The computing device may be any device capable of executing a gaming application, such as, a personal computer, a tablet computer, a hand held gaming device, a portable computing device, etc. The computing device (e.g., personal computer, or PC) 310A may be coupled to a PC based application store that provides more computationally intensive gaming applications that are executable on PC based computing devices (e.g., device 310A), as opposed to less computationally powerful mobile devices, such as, gaming device 310B.

The optimization support server 340 is configured to provide current settings for various hardware and/or software configurations (e.g., in-game graphic settings) that are optimized for a particular gaming application. For example, settings include anti-aliasing, ambient occlusion, anisotropic filtering, bullet decals, depth of field, frame rate, resolution, texture quality, etc. These settings are determined through extensive testing of the gaming application as executed under various hardware and/or software configurations. For instance, the testing may include automated testing, as well as manual testing by human testers. As such, for a given gaming application and a particular hardware and/or software configuration platform, optimized settings are determined and stored at the optimization support server 340. In addition, the optimization support server 340 is configured to deliver a particular grouping of optimized settings to a particular gaming platform, to include hardware and/or software configurations, through the network 350. Network 350 generally represents any telecommunication or computer network including, for example, an intranet, a wide area network (WAN), a local area network (LAN), a personal area network (PAN), or the Internet. In that manner, no matter what the hardware and/or software configuration platform that a user has for executing the gaming application, an optimal group of configuration settings is available at the optimization support server 340.

In one embodiment, the computing resource is configured as an end terminal and/or gaming device 310B used for displaying video in combination with a GRID system 330 that provides computing and graphics processing at a back-end server. In particular, the GRID system 330 provides cloud based virtualized computing and graphics processing for remote displays. For example, the GRID system 330 may include a number of virtual computing processing units (CPUs) and graphics processing units (GPUs) that in combination support one or more gaming applications. In one case, the end terminal and/or gaming device 310B is coupled to a virtual CPU and GPU combination at the GRID system 330 through the network 350.

In one embodiment, GRID system 330 provides network resources managed by one or more host operating systems, wherein the network resources (e.g., CPU, GPU, etc.) are virtualized and shared within one or more virtual machines (VMs) and external communication networks. That is, one or more host systems manage a plurality of physical servers that support a plurality of virtual machines. In particular, the host manager in conjunction with other elements (e.g., hypervisor) creates, manages, and runs a plurality of virtual machines. In one implementation, the GRID system 330 may include a distributed network of computing resources made available through a communication network. In that manner, the GRID system 330 provides complete, virtualized gaming systems that are also designed to provide high power graphics processing that are accessed through end terminals and/or gaming devices (e.g., device 310B).

As previously described, the optimization support server 340 is configured to provide current settings for various hardware and/or software configurations (e.g., in-game graphic settings), including those associated with virtualized CPUs and GPUs supported by the GRID system 330, that are optimized for a particular gaming application. As such, a user may load a gaming application using a virtualized CPU and/or GPU supported at the GRID system 330, wherein the virtual CPU and/or GPU combination is associated with a particular hardware and/or software configuration that is optimized using the optimization support server 340.

In another embodiment, the gaming device 310B is a stand-alone device that is configured for executing and controlling the actions within a gaming application. In one implementation, the gaming device 310B comprises a handheld gaming console. For instance, the gaming device 310B includes a processor for executing an internally stored gaming application. The gaming device 310B also includes a display (e.g., a high-definition display) for the display of various images, including video from a locally executing gaming application, video from a remotely executing gaming application, secondary or supplemental video of a gaming application related to a gaming application, etc. In one embodiment, the gaming device 310B is communicatively coupled (e.g., directly or indirectly through a WAN, LAN, Wi-Fi, etc.) to various secondary, local devices, such as, those within a short distance of each other, like in a home environment. For example, gaming device 310B may act as a display for a personal computer or mobile device that are executing a gaming application, or an TV monitor (e.g., high-definition television) for displaying video from a gaming application executed on the gaming device 310B. In another embodiment, the gaming device 310B is communicatively coupled (e.g., through WAN, LAN, internet, etc.) to remote devices, such as, remote web servers, the optimization support server 340, GRID servers 330. In addition, the gaming device 310B is coupled with a mobile based application store that is affiliated with an entity supporting a gaming environment and/or community accessible through the handheld gaming device 310B, such as, TegraZone associated with Nvidia Corp. that manages a suite of Google Android based gaming applications suitable for execution on the gaming device 310B.

FIG. 4 is a block diagram of an optimizing management module 400 configured for applying optimal settings to a game settings file that is associated with a specific gaming application as executed on a computing device, in accordance with one embodiment of the present disclosure. The optimizing management module 400 is configured to have the opportunity to apply pre-defined optimal settings to a gaming application before the user fully plays the application for the first time.

Optimizing management module 400 includes an updating module 410 configured for receiving current information regarding optimal settings. For example, updating module 410 is communicatively coupled to the optimization support server 340 of FIG. 3, and periodically receives an updated or current list of supported applications and information related to those applications used to apply optimal settings. The related information includes, per application, one or more groupings of pre-defined optimal settings, wherein each grouping is associated with a corresponding hardware configuration used to execute and display that gaming application.

Generally, performance is inversely related to image quality. That is, improving performance of an application by adjusting settings, such as, improving or expanding the execution of the application on a given hardware platform, comes at a cost of image quality. The pre-defined optimal settings provide the best image quality and performance for a given configuration of hardware. This optimization information is updated periodically (e.g., hourly, once a day, etc.) and in one embodiment locally stored in storage 420 so that the most up-to-date optimization information is available to the user. In other embodiments storage 420 is remote from the computing device interfacing with the user.

Optimizing management module 400 includes a gaming application detector 430 that is configured for discovering when an application is being invoked for the first time, sometime after the application has been installed. For example, detector 430 is configured to periodically poll a list of gaming applications supported by service providing optimal settings to gaming applications (e.g., as serviced by the optimization support server 340) which have started or ended within a past period.

In addition, the resource discovery module 440 is configured to determine the hardware configuration for a particular computing device used to execute the gaming application. In that manner, the user has the opportunity to play the gaming application under optimal settings for a given hardware configuration.

The optimizer 450 is configured to apply optimal settings to a game settings file 460 associated with the gaming application. That is, upon invocation, an associated game settings file is generated or pre-defined. The game settings file determines the way the gaming application is executed, and as applied will affect the way the game looks and performs. For purposes of illustration, settings in the file include, but are not limited to, anti-aliasing, anisotropic filtering, water quality, shadow quality, hair quality, sharpening, and texture resolution. For example, if a user has a high-powered computing device, but the default settings in the game settings file are defined for an average, lower performing machine to obtain better performance at the cost of image quality, then the user will be presented with an average view of the gaming application. In that case, the user's high powered computing device is not being used to its full capacity. On the other hand, the optimizer 450 adjusts the game settings file 460 to include settings that are optimized for the high-powered computing device of the user.

FIG. 5 is a flow diagram 500 illustrating a method for applying optimized settings to a game settings file that is associated with a gaming application as executed on a particular computing device, in accordance with one embodiment of the present disclosure. In still another embodiment, flow diagram 500 illustrates a computer implemented method for applying optimized settings to a game settings file that is associated with a gaming application as executed on a particular computing device. In another embodiment, flow diagram 500 is implemented within a computer system including a processor and memory coupled to the processor and having stored therein instructions that, if executed by the computer system causes the system to execute a method for applying optimized settings to a game settings file that is associated with a gaming application as executed on a particular computing device. In still another embodiment, instructions for performing a method as outlined in flow diagram 500 are stored on a non-transitory computer-readable storage medium having computer-executable instructions for causing a computer system to perform a method for applying optimized settings to a game settings file that is associated with a gaming application as executed on a particular computing device. The method outlined in flow diagram 500 is implementable by one or more components of the computer system 100 and client device 200 of FIGS. 1 and 2, respectively.

At 510, the method includes detecting a newly discovered gaming application on a computing device. In one implementation, the method includes performing a scan for a game starting or ending execution within a previous time period on the computing device.

Also, during detection, the method includes determining a first invocation of the gaming application. For instance, it is determined whether optimization for this gaming application has been previously addressed. For example, the scan may include includes polling a list of applications which has started or ended within a past period (e.g., last 5 seconds). The list of applications includes those applications that have pre-defined optimal settings available, one of which can be applied to the user's computing system (e.g., its hardware configuration).

At 520, the method includes receiving an instruction to optimize the newly discovered gaming application. That is, the user is given an opportunity to apply optimal settings to a computing device that is configured to execute and display the newly discovered gaming application. The user elects to optimize the computing device, and enables the delivery of an instruction to optimize the computing device. In one implementation, a pop-up notification appears (e.g., “Optimal Game Settings Are Available. Enter CTRL+F6 to Apply Settings”), and once the user enters the appropriate key sequence, the necessary operations are performed to apply optimal settings to the game settings file.

In particular, at 530 the method includes determining a hardware configuration for the computing device. For example, the hardware configuration may include the type and model of processor or processors available for executing the gaming application, the type and model of graphics processor or processors available, the type and model of display, etc.

At 540, the method includes accessing pre-defined optimal settings based on the gaming application and the hardware configuration. In one embodiment, the pre-defined optimal settings are locally stored, and are periodically updated to include the most current optimal settings for the gaming application, in association with one or more hardware configurations. In another embodiment, the pre-defined optimal settings are stored in a location remote from the computing device.

At 550, the method includes configuring the game settings file to include, at least in part, the pre-defined optimal settings. For example, the method includes writing the pre-defined optimal settings into the game settings file that is associated with the gaming application.

FIGS. 6A-B is a flow diagram 600 illustrating a method for applying optimized settings to a game settings file upon first invocation of a gaming application as executed on a computing device, in accordance with one embodiment of the present disclosure. For example, the method outlined in flow diagram 600 discloses the application of optimal settings under various scenarios to accommodate different manifestations of creating game settings files for gaming applications. The method outlined in flow diagram 600 is implementable by one or more components of the computer system 100 and client device 200 of FIGS. 1 and 2, respectively.

At 605, the method includes scanning for a newly executed or newly exited gaming application within a previous time period (e.g., 5 seconds). The scanning is performed to detect a gaming application that potentially is being invoked for the first time. For example, a user may install a gaming application on a computing device. The gaming application will run for the first time, and in particular, is invoked for the first time. During invocation, a game settings file is created, wherein the settings in the file determine the way the gaming application is executed and displayed in or on that particular computing device, and as applied will affect the way the game looks and performs. As such, at 605, the method includes detecting a newly executed or newly exited gaming application.

At 610, the method includes determining whether the gaming application is supported by a service providing the best user experience when playing the gaming application. That is, are there pre-defined optimal settings for this gaming application configured for one or more hardware configurations potentially used by one or more users playing the gaming application. As such, optimal settings may be delivered as an update from optimization servers (e.g., the optimization support server 340 of FIG. 3), along with validation fingerprints, and locally stored within a gaming profile on the computing device of the user. In still another embodiment, a particular application is monitored, but not necessarily supported with optimal settings. In addition, the method determines whether the gaming application is on a black list. Also, the method may determine if the gaming application is legitimate or validated to the user. In one implementation, a flag is set to true if and only if the gaming application is supported with optimal settings, is verified via fingerprint. Otherwise, the flag is defaulted to false. If the gaming application is supported, the method proceeds to 615. On the other hand, if the gaming application is not supported, or if the user has disabled the feature providing for an opportunity to use and install optimal settings, then the method ends.

At 615, the method includes determining whether the newly discovered gaming application is listed on a personal list of installed, and previously invoked and supported applications. In particular, it is determined whether or not the opportunity to apply optimal settings for this gaming application has been previously addressed. In short, this method determines whether the game is being invoked for the first time. If the chance to use optimal settings has been previously addressed (e.g., presented to the user and either accepted for optimization or declined to use default settings), then the gaming application is not being invoked for the first time, and the method ends. On the other hand, if the chance to use optimal settings has not been previously addressed, then the gaming application is being invoked for the first time, and the method proceeds to 620. In one implementation, a corresponding flag is set to true when a gaming application has been considered for optimization (even if the user chooses not to optimize), and set to false by default.

At 620, the method includes determining whether an optimizing query has been launched in relation to the newly discovered gaming application. That is, on some gaming applications, the game settings file is created and finalized only upon exiting. As such, applying the optimal settings to the game settings file is performed only after the user has already been queried, and an exit from the gaming application has been performed. If a query has been presented in association with a first invocation, then the method proceeds to common point B, which continues in FIG. 6B. On the other hand, if a query has not been presented, then the method proceeds to 625.

At 625, the method includes presenting an optimizing query to the user. For example, the query includes a pop-up notification or splash screen (e.g., “Optimal game settings are available. Enter Cntl+F6 to optimize your gaming application. Note your gaming application will be restarted in order to apply the settings.”). In this manner, the user is given the option to optimize the hardware configuration used to execute and display the gaming application. That is, the user has control over the gaming settings, and the game settings file is not automatically updated. In other embodiments, the game settings file may be automatically updated. Continuing with the example, the notification is visible even with a full-screen game, such as, with an overlay. The pop-up notification appears for a period of time (e.g., a few seconds) upon first invocation, which is enough to give the user the opportunity to decide whether to optimize the game settings file.

At decision step 630, the method determines whether the user wants to optimize the gaming application for the particular hardware configuration associated with the computing device used to execute and display the gaming application. That is, a reply to the query is examined to determine if the user want to optimize the game settings file of the gaming application. If the user does not want to optimize (e.g., passively ignores the notification or actively declines), then the method ends. On the other hand, if the user wants to optimize (e.g., actively accepts the query to optimize), then the method proceeds to common point A, which is continued in FIG. 6B.

In FIG. 6B, continuing from common point A, the method determines at decision step 635 whether the newly discovered gaming application writes settings in the game settings file after a delay upon first invocation. That is, some gaming applications will configure and finalize the game settings file after a pre-determined period of time (e.g., 2 seconds, 30 seconds, 2 minutes, etc.). In this case, the game settings file needs to be fully configured before optimization can occur. As such, if the gaming application does write settings after a delay, then the method proceeds to 640 and waits for the pre-defined delay so that the game settings file is fully configured. For instance, the optimization method sleeps for a given amount of time to ensure that the gaming application has completed all of its writings to the game settings file.

For a gaming application that writes to the game settings file after a delay, at 660, the method forces (e.g., automatically) an exit from the gaming application. Thereafter, at 665, the optimal settings are automatically applied to the game settings file. In addition, at 670, the gaming application is added to a personal list of previously addressed (e.g., whether optimization is desired, or not) gaming applications supported with optimal settings. At 675, the gaming application is restarted, so that the user is able to enjoy the game with a computing device that is configured with the most optimal settings for that gaming application. In that manner, the best gaming experience is provided to the user.

In still another embodiment, the game settings file is locked after optimization under any write to game settings file condition. In that case, no additional writes or changes to the game settings file can be made by the gaming application, which could cause file corruption (e.g., during race conditions).

On the other hand, if the gaming application does not write settings to a game settings file after a delay, then the method proceeds to decision step 645, where the method determines whether the newly discovered gaming application writes settings upon exit. If true, the method proceeds to 655, and instructs the user to manually exit the gaming application, in one implementation. At that point, the method proceeds back to 605.

However, it is understood that the process for updating the gaming application has been previously initiated, but not completed, in order to finalize the optimization of the gaming application. For instance, a flag may be set indicating that the optimizing query has been launched but not fully addressed. In this manner, the process proceeds from 605, past 610 after reaffirming that this gaming application has optimal settings available, after determining at 615 that the newly terminated gaming application has not yet been added to the personal list of gaming applications that have been fully addressed for optimization, through decision step 620 that determines that an optimization query has been launched but not fully addressed, and back to common point B, which is continued on FIG. 6B.

At that point, for a gaming application that writes settings upon exit, the method from common point B determines whether the application has been gracefully exited by the user. If the application has not been exited, the method may continue to 665 to ask the user to exit the gaming application. On the other hand, if the user has exited the application, the method automatically applies optimal settings to the game settings file at 665; adds the gaming application at 670 to a personal list of previously addressed (e.g., whether optimization is desired) gaming applications supported with optimal settings; and restarts the gaming application at 675. In that manner, the user is able to enjoy the game with a computing device that is configured with the most optimal settings for that gaming application in order to provide the best gaming experience to the user.

On the other hand, if the gaming application does not write settings to a game settings file upon exit, then the method proceeds to decision step 650, where the method determines whether the newly discovered gaming application writes settings upon change. If false, the method ends. If true, the method proceeds to 660 and forces (e.g., automatically) an exit to the gaming application. That is, this gaming application that writes on change can be treated similarly as a gaming application that writes settings after a delay, where the delay is zero (0) seconds. Thereafter, the optimal settings are applied automatically at 665; the gaming application is added at 670 to a personal list of previously addressed gaming applications; and restarts the gaming application at 675 with a hardware configuration that is optimized to the gaming application to give the best gaming experience to the user.

Thus, according to embodiments of the present disclosure, systems and methods are described providing for applying optimal settings for a gaming application as executed on a specific computing device to enhance the overall gaming experience of a corresponding user.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples in that many architectural variants can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Embodiments according to the present disclosure are thus described. While the present disclosure has been described in particular embodiments, it should be appreciated that the disclosure should not be construed as limited by such embodiments, but rather construed according to the below claims.

1. A non-transitory computer readable medium having computer executable instructions for causing a computer system to perform a method of optimization, comprising;
detecting a newly discovered gaming application on a computing device by performing a scan for a game starting or ending execution within a previous time period on said computing device;
receiving an instruction to optimize said newly discovered gaming application;
determining a hardware configuration for said computing device;
accessing pre-defined optimal settings based on said gaming application and said hardware configuration;
writing said pre-defined optimal settings into a game settings file associated with said gaming application.

2. The computer readable medium of claim 1, wherein said detecting a gaming application in said method further comprises:
determining a first invocation of said gaming application.

3. The computer readable medium of claim 2, wherein said determining a first invocation in said method comprises:
determining whether said gaming application is present on a personal list of installed games on said computing device that have been queried and addressed for optimization.

4. The computer readable medium of claim 3, wherein said method further comprises:
adding said gaming application to said personal list.

5. The computer readable medium of claim 1, wherein said settings that are optimized in said method comprise at least one setting from a group consisting essentially of;
anti-aliasing;
anisotropic filtering;
water quality;
shadow quality;
hair quality; and
texture resolution.

6. The computer readable medium of claim 1, wherein said receiving an instruction in said method further comprises:
providing a query asking whether optimization of said settings in said game settings file is desired.

7. The computer readable medium of claim 1, wherein said method further comprises:
determining passing of a time period during a first invocation of said gaming application, wherein said game settings file is initialized with manufacture settings during said time period;
forcing exit of said gaming application; and
wherein said writing said pre-defined settings comprises over-writing said manufacture settings in said game settings file with said pre-defined optimal settings.

8. The computer readable medium of claim 1, wherein said method further comprises:
forcing exit of said gaming application, wherein said gaming application initializes settings in said game settings file after exiting from a first invocation of said gaming application; and
wherein said writing said pre-defined settings comprises over-writing initialized settings in said game settings file with said pre-defined optimal settings.

9. The computer readable medium of claim 1, wherein said writing said pre-defined settings in said method further comprises:
forcing exit of said gaming application; and
creating said game settings file, wherein settings in said game settings file are created upon a change to a setting.

10. A computer system comprising:
a processor; and
memory coupled to said processor and having stored therein instructions that, if executed by a computer system, causes said computer system to execute a method for optimization, comprising:
detecting a newly discovered gaming application on a computing device by performing a scan for a game starting or ending execution within a previous time period on said computing device;
receiving an instruction to optimize said newly discovered gaming application;
determining a hardware configuration for said computing device;
accessing pre-defined optimal settings based on said gaming application and said hardware configuration;
writing said pre-defined optimal settings into a game settings file associated with said gaming application.

11. The computer system of claim 10, wherein said detecting a gaming application in said method further comprises:
determining a first invocation of said gaming application.

12. The computer system of claim 10, wherein said settings that are optimized in said method comprise at least one setting from group consisting essentially of;
anti-aliasing;
anisotropic filtering;
water quality;
shadow quality;
hair quality; and
texture resolution.

13. The computer system of claim 10, wherein said receiving an instruction in said method further comprises:
providing a query asking whether optimization of said settings in said game settings file is desired.

14. The computer system of claim 10, wherein said method further comprises:
determining passing of a time period during a first invocation of said gaming application, wherein said game settings file is initialized with manufacture settings during said time period;
forcing exit of said gaming application; and
wherein said writing said pre-defined settings comprises over-writing said manufacture settings in said game settings file with said pre-defined optimal settings.

15. The computer system of claim 10, wherein said method further comprises:
forcing exit of said gaming application, wherein said gaming application initializes settings in said game settings file after exiting from a first invocation of said gaming application; and
wherein said writing said pre-defined settings comprises over-writing initialized settings in said game settings file with said pre-defined optimal settings.

16. The computer system of claim 10, wherein said writing said pre-defined settings in said method further comprises:
forcing exit of said gaming application; and
creating said game settings file, wherein settings in said game settings file are created upon a change to a setting.

17. A system for optimization, comprising:
a processor;
a gaming application detector controlled by said processor and configured to detect a newly discovered gaming application on a computing device by performing a scan for a game starting or ending execution within a previous time period on said computing device;
a resource discovery module controlled by said processor and configured to determine a hardware configuration for said computing device;
an optimizer controlled by said processor and configured to receive an instruction to optimize said newly discovered gaming application, to access pre-defined optimal settings based on said gaming application and said hardware configuration, and to write said pre-defined optimal settings into a game settings file associated with said gaming application.

18. The system of claim 17, wherein said gaming application detector is configured to perform a scan for a game starting or ending execution within a previous time period on said computing device, and to determine a first invocation of said gaming application.

19. The system of claim 17, wherein said optimizer is configured to determine passing of a time period during a first invocation of said gaming application, wherein said game settings file is initialized with manufacture settings during said time period, to force an exit of said gaming application, and to over-write said manufacture settings in said game settings file with said pre-defined optimal settings

20. The system of claim 17, wherein said optimizer is configured to force exit of said gaming application, wherein said gaming application initializes settings in said game settings file after exiting from a first invocation of said gaming application, and to over-write initialized settings in said game settings file with said pre-defined optimal settings.

21. The computer readable medium of claim 2, wherein said determining a first invocation in said method comprises creating a game settings file of said gaming application.

22. The computer readable medium of claim 1, wherein said writing said pre-defined optimal settings into a game settings file associated with said gaming application comprises locally storing said settings within a gaming profile in said computer system.

23. The computer readable medium of claim 1, wherein said detecting a newly discovered gaming application on a computing device comprises determining whether said gaming application is validated to the user, further wherein said accessing pre-defined optimal settings and said writing said pre-defined optimal settings into a game settings file are performed when said gaming application is validated to the user.
